(19) United States
(12) Patent Application Publication
(10) Pub. No.: US 2006/0138767 A1
(43) Pub. Date: Jun. 29, 2006

(54) Single-ply article for a tube container

(76) Inventor: Joseph D. Franko SR., Ham Lake, MN (US)

Correspondence Address: WALTER K. ROLOFF, 490 HARBOR COURT, SHOREVIEW, MN, 55126, US

(21) Appl. No.: 11/362,459

(22) Filed: Feb. 24, 2006

Related U.S. Application Data
(63) Continuation-in-part of application No. 10/005,757, filed on Nov. 2, 2001.

(51) Int. Cl. B42D 15/00

(52) U.S. Cl. 283/81

(57) ABSTRACT

A single-ply article for a tube container includes a tube container having a product dispensing end and a filling end opposite the product dispensing end. The tube container has a crimp method seal at its filling end that is created after filling the tube container with a selected product. A single-ply article is securely joined to the filling end of the tube container (i) by way of the crimp method seal, (ii) after the tube container is crimped shut, in a two-step operation, or (iii) as a separate, prior step before said tube container is filled with a selected product and crimped shut.

### CROSS-REFERENCE TO RELATED APPLICATION

The present application is a continuation-in-part of co-pending U.S. patent application Ser. No. 10/005,757 filed Nov. 02, 2001, the disclosure of which is specifically incorporated herein by reference thereto.

### FIELD OF THE INVENTION

The present invention relates generally to single-ply articles including labels, cards, sheets, coupons, and the like. The invention relates specifically to such a single-ply article for a tube container.

### BACKGROUND OF THE INVENTION

In the printing arts, and in particular in the commercial printed label art for labeling and decorating consumer products, there exists a continual demand for labels and decorations which not only appeal to consumers, but also bear ever increasing amounts of printed information. For example, labels for identification of consumer health care and pharmaceutical products are often required by governmental regulations to describe in painstaking detail their compositions and ingredients. As new food and drug laws are passed, regulations require the inclusion of increasing amounts of label information. Manufacturers of consumer products and their packaging vendors have devised various schemes for inclusion of such extensive information. Among these are simply printing the information in small type on a product container box or carton, or including an information insert sheet within the box or carton. Obvious drawbacks to these schemes include increased packaging costs associated with a box or carton, and the fact that boxes, cartons, and insert sheets are often promptly discarded by a consumer.

In general in the labeling and packaging arts, various forms of so-called “extended text”, “expanded content”, and “booklet type” labels (collectively, “extended text labels”) have been proposed to provide increased printed information. In a booklet type label, a base ply is joined to a top ply via an adhesive coupling or “hinge” between the two plies. An example of this type of label is disclosed in U.S. Pat. No. 5,264,265 issued to Kaufmann, entitled “PEEL-BACK RE-SEALABLE MULTI-PLY LABEL”. Attempts have been made to provide extended text labeling for particular containers and unique uses associated therewith. For example, in U.S. Pat. No. 5,967,560 issued to Seidl entitled “HANGING LABEL”, a label includes an integral suspension strap for suspending a bottle (e.g., an intravenous infusion bottle) to which the label is attached.

However, no provision has heretofore been made for simply and inexpensively labeling a tube container with an extended text label.

In U.S. Pat. No. 6,129,959 issued to Mercer, et al., entitled “SLEEVE LABEL WITH INTEGRAL FLAP AND/OR HEADER”, a tubular sleeve of polymeric film is adapted for use as a sleeve label on a consumer product such as a plastic bottle or jug. The sleeve label may provide a tear-off coupon. In U.S. Pat. No. 6,162,158 also issued to Mercer, et al., entitled “METHOD OF FABRICATING A SLEEVE LABEL WITH MULTILAYERED INTEGRAL FLAPS”, a sleeve label is fabricated from a sheet of multi-folded polymeric material. Additional folding results in a multi-page booklet type label for a bottle or jug.

Labels such as those disclosed above, however, are not suited for providing extended text labeling of tube containers. Specifically, tube containers typically do not have a uniform circumference, and are subject to deformation in use by squeezing to force product out therefrom. Thus, the disclosed labels cannot be satisfactorily utilized with such tubes.

In co-pending U.S. patent application Ser. No. 10/005,757 (U.S. Pat. Applic. Pub. No. 2003/0085564) incorporated herein by reference thereto, an extended text label is provided for a tube container with the extended text label including a crimp edge. The crimp edge is securely joined to the filling end of the tube container by way of a crimp method seal.

In U.S. Pat. No. 6,786,515 incorporated herein by reference thereto, a tube container with an integral panel for carrying a label includes a label panel in proximity to a sealing portion of the tube container, with the label panel being integrally formed from material forming the tube container between the sealing portion and a filling end of the tube container. An expanded content label may then be secured to the label panel.

In co-pending U.S. patent application Ser. No. 10/919,653 (U.S. Pat. Applic. Pub. No. 2005/0012325) incorporated herein by reference thereto, a tube container with an integral accessory panel includes an accessory panel which is integrally formed from selected tube material of the tube container, between an intermediate sealing portion and a filling end of the tube container.

The aforementioned patents and publications, however, do not disclose a single-ply article, such as, for example, a label, a card, a sheet, or a coupon, for a tube container where that single-ply article is secured to the tube container at its sealing portion or filing end.

Therefore, there exists a need for a single-ply article for a tube container that may be readily secured to a tube container, and that may be simply and inexpensively produced.

It is generally accepted and well-known in the label making arts that in-line printing and converting processes offer the most cost-effective label production. An exemplary in-line method is disclosed in U.S. Pat. No. 4,849,043 issued to Instance, entitled “METHOD OF PRODUCING LABELS”. Therefore, there also exists a need for an in-line converting and printing process for manufacture of such a single-ply article for a tube container.

### SUMMARY OF THE INVENTION

An object of the present invention is to provide a single-ply article for a tube container that may be readily secured to the tube container.

Another object of the present invention is to provide a single-ply article for a tube container that may be simply and inexpensively produced.

In accordance with the present invention, a single-ply article for a tube container includes a tube container having a product dispensing end and a filling end opposite the product dispensing end. The tube container has a crimp method seal at its filling end that is created after filling the tube container with a selected product. A single-ply article is securely joined to the filling end of the tube container (i) by way of the crimp method seal, (ii) after the tube container is crimped shut, in a two-step operation, or (iii) as a separate, prior step before said tube container is filled with a selected product and crimped shut.

### BRIEF DESCRIPTION OF THE DRAWINGS

FIG. 1 is an illustration of a conventional tube container.

FIG. 2 is an illustration of an extended text label for a tube container, constructed in accordance with the present invention.

FIG. 3 is a magnified cross-sectional view of the extended text label for a tube container of FIG. 2.

FIG. 4 is an illustration of the extended text label for a tube container of FIG. 2, shown as having been secured to the tube container of FIG. 1.

FIG. 4a is a side view of the extended text label for a tube container of FIG. 2, shown as having been secured to the tube container of FIG. 1.

FIG. 5 is an illustration of another alternative embodiment of the label of FIG. 2, constructed in accordance with the present invention.

FIG. 6 is an illustration of yet another alternative embodiment of the label of FIG. 2, constructed in accordance with the present invention.

FIG. 7 is a schematic diagram of a manufacturing method for production of an extended text label for a tube container of the present invention.

FIG. 8 is an illustration of a single-ply article for a tube container, shown as having been secured to the tube container of FIG. 1.

### DETAILED DESCRIPTION OF THE INVENTION

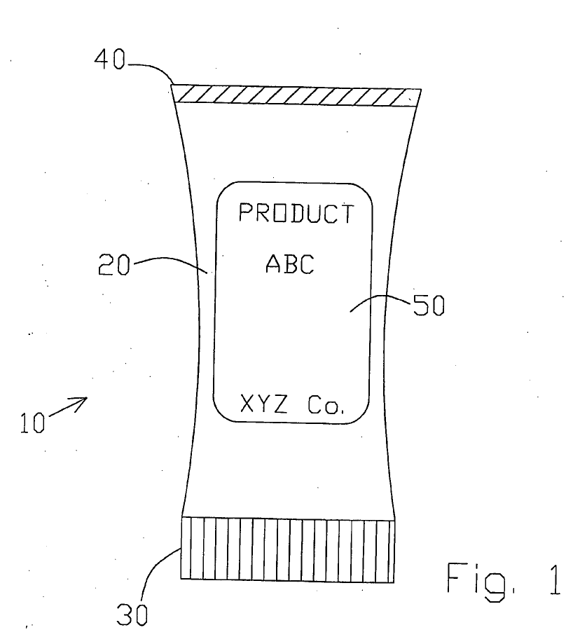

Referring to FIG. 1, there shown is a conventional tube container 10. Container 10 is typically fabricated from a pliable material 20. Commonly, the fabrication is accomplished by either a so-called extrusion process, where the pliable tube material may be a plastic which is extruded into a tube, or by a so-called lamination process, where the pliable tube material may be a plastic, a foil, or any combination thereof, which is ultimately rolled or otherwise formed into a tube.

As understood by those skilled in the packaging arts, various plastics, foils, and metals that may be utilized for material 20 may be used in various combinations with each other.

As is well known, container 10 includes a product dispensing end 30 and an opposing filling end 40. Dispensing end 30 commonly includes a dispensing cap whereby a product within container 10 may be squeezed out therefrom.

Container 10 also commonly includes a product identification label 50. Label 50 may be provided by way of, for example, a simple adhesive label, or by any number of direct decorating techniques.

Although not depicted in FIG. 1, in an automated production system of a finished consumer product including container 10, a semi-liquid product is introduced thereto via filling end 40. After container 10 has been filed with the product, container 10 passes in the automated production system to a sealing station employing a sealing method for sealing container 10 at filling end 40. The sealing method typically employs either an electric heat element/water-cooled device (for plastic tubes) or an ultrasonic heat sealing device (for foil tubes). The sealing method may be provided by any commercially available tube filling equipment.

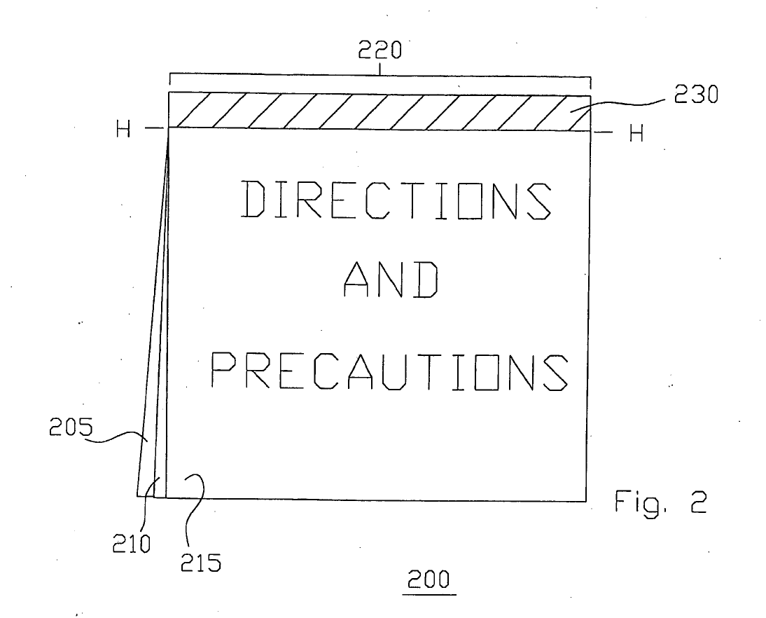

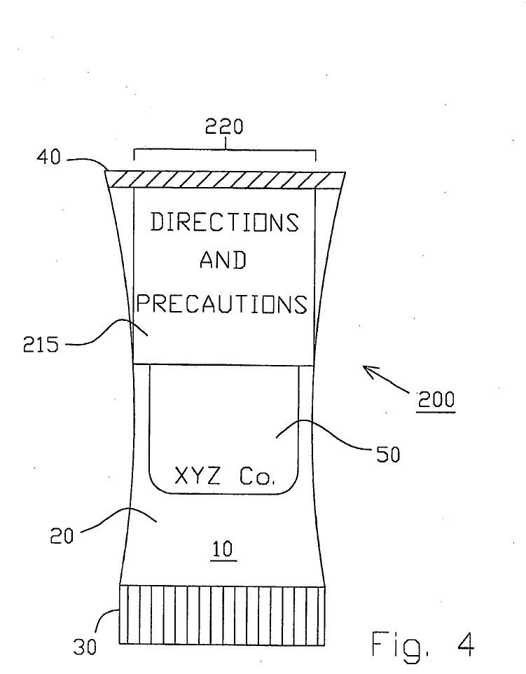

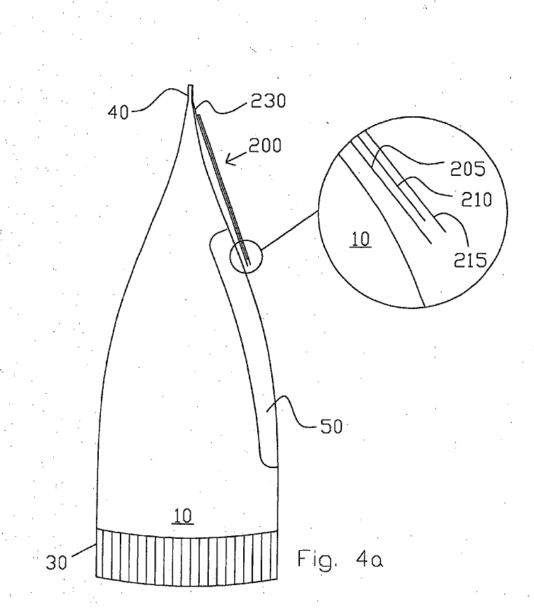

In FIG. 2, an extended text label for a tube container 200 (hereinafter, “label 200”) is depicted. Therein, label 200 includes a base ply 205 and a top ply 215. Label 200 may include any number of intermediate plies 210. Conventionally, base ply 205 and top ply 215 (along with intermediate plies 210, if any) are adhesively joined in hinge fashion about axis H-H along longitudinal hinge portion 220. Hinge portion 220 along axis H-H facilitates opening and closing of label 200 in use, in booklet fashion. Label 200 further includes a pliable attachment tongue 230, which is an extension of base ply 205. It is to be appreciated that tongue 230 allows label 200 to conform in repose to container 10 (as will be described in FIG. 4a).

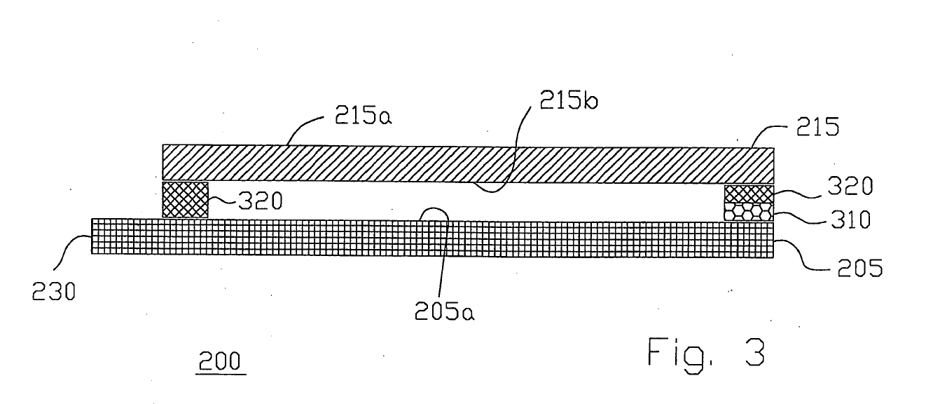

As is to be understood with particular reference to FIG. 3, label 200 may be capable of being releasably resealed, by way of, for example, applications of release coating 310 and adhesive coating 320 to top surface 205a of base ply 205 and to bottom surface 215b of top ply 215 (any plies 210 have been omitted from the figure). It is to be appreciated that adhesive coating 320 securely bonds the plies of label 200 at hinge portion 220, while adhesive coating 320 in combination with release coating 310 creates a resealable closure for label 200 as may be desired in a particular application.

Coatings 310 and 320 are preferably chosen from water-based, solvent-based, ultraviolet light activated, and hot melt coatings as are commercially available from Craig Adhesives & Coatings Co. of Newark, N.J., and Northwest Coatings Corp. of Oak Creek, Wis.

Plies 205, 210 (if any) and 215 are preferably any commercially available web-like materials that are capable of use in an in-line printing and converting process (as will be further described relative to manufacture of label 200). As used herein, however, “web-like materials” denotes any suitable material, including paper, film, polypropylene, polyethylene, polyester, polyvinylchloride, polystyrene, foil, and ethylene vinyl acetate. Each ply of label 200 is preferably capable of bearing printed graphics thereon (as shown on top ply 215 in FIG. 2) to maximize an amount of information that may be conveyed by label 200.

FIGS. 4 and 4a depict label 200 of FIG. 2 as having been secured by a sealing method to container 10. As mentioned above, with particular reference now to FIG. 4a, tongue 230 of label 200 allows label 200 to better conform in repose to container 10. Specifically, as may be ascertained from the profile figure, tongue 230 provides a pliable elongated attachment point for label 200 to container 10. By choice of a suitable length of tongue 230, label 200 is prevented from appreciably protruding outwardly from container 10.

It is to be noted that the sealing method of attachment of label 200 to container 10 in FIGS. 4-4a may be accomplished in a one-step operation as described above, variously referred to as a thermoplastic bonding/sealing technique. Alternatively, the sealing method may take a two-step operation, wherein container 10 is first sealed along filling end 40 in the thermoplastic bonding/sealing technique (after a product is filled therein). Then, label 200 is adhered to filling end 40 by way of a heat-activated adhesive coating provided along tongue 230. It is to be appreciated that heat required to activate the adhesive coating along tongue 230 is of a lesser temperature than that of the thermoplastic bonding/sealing technique utilized to seal filling end 40, so that filling end 40 is not compromised.

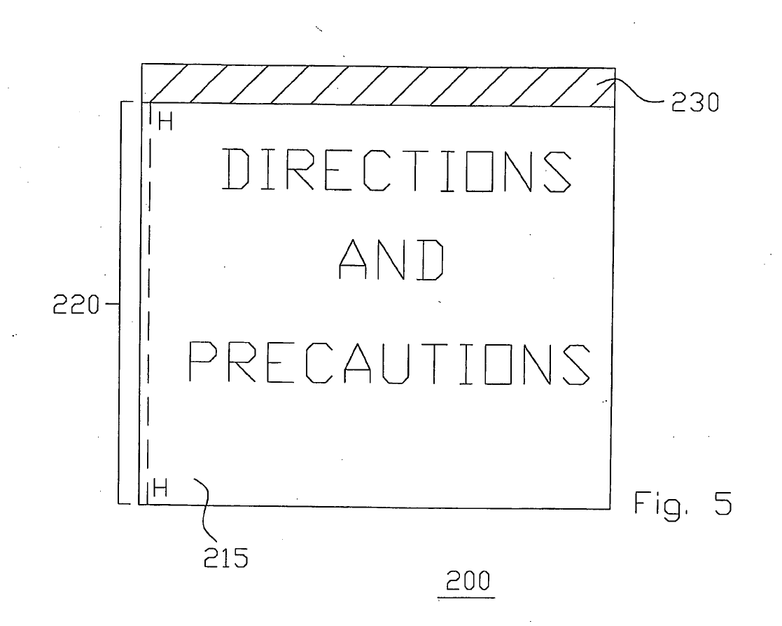

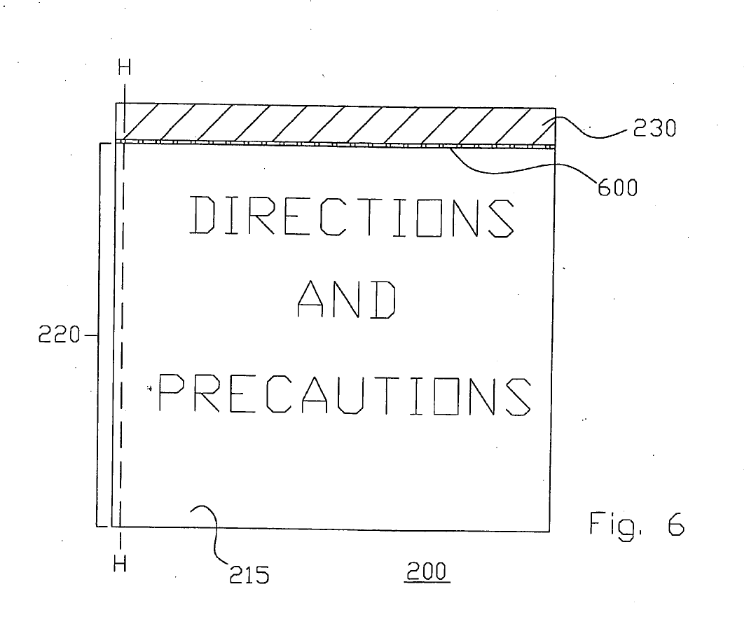

Turning, now, to FIGS. 5 and 6, there illustrated are alternative embodiments of label 200. Specifically, in FIG. 5, hinge axis H-H is shown as being orthogonal to attachment tongue 230. It is to be appreciated that in this configuration, label 200 may be opened in booklet fashion in a left-to-right sense (as contrasted by a top-to-bottom sense in FIG. 2). In FIG. 6, label 200 of FIG. 5 includes a perforated or scored tear-off portion 600 along tongue 230. In this embodiment, label 200 may be permanently removed or torn off from tongue 230 and container 10.

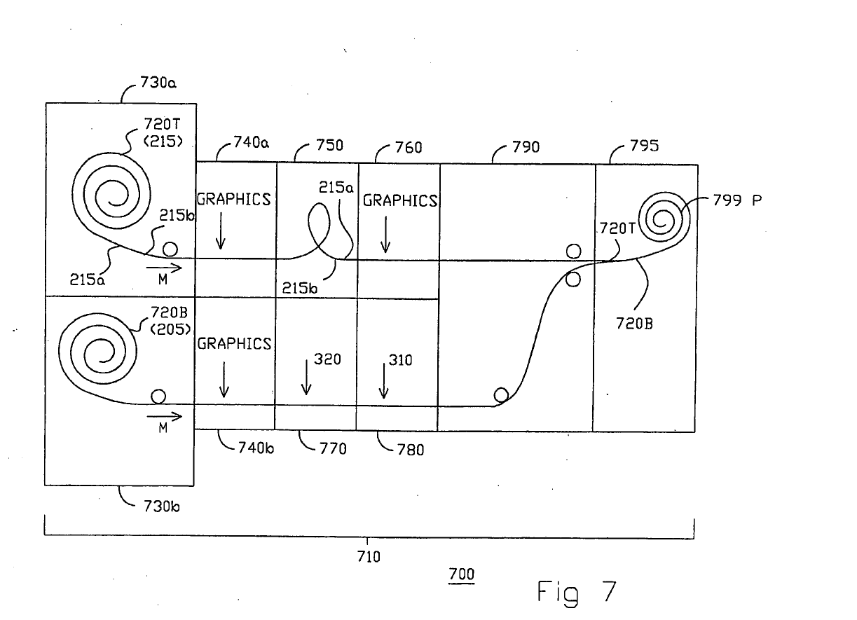

With attention, now, to FIG. 7, there depicted in schematic fashion is an exemplary in-line web press manufacturing installation 700 including multi-unit in-line printing and converting press 710, for mass production of label 200.

Multi-unit press 710 of installation 700 includes unwind units 730a and 730b, first and second printing units 740a and 740b, a web turning unit 750, a third printing unit 760, a first coating unit 770, a second coating unit 780, a nip roller web joining unit 790, and a final re-wind unit 795, as will now each be further described in construction of a web of labels 200.

It is to be understood that press 710 is selectively capable of providing a variable number of print stations for application and drying of pigmented inks, coatings, and adhesives. As understood by those of ordinary skill in the printing arts, the exemplary multi-unit press 710 may be any suitable narrow- or wide-web press such as a flexographic, letterpress, gravure, screen, or offset press. Such presses are commercially available from, for example, Comco International of Milford, Ohio, or Mark Andy Inc. of St. Louis, Mo.

As a simple example of construction of labels 200 having no intermediate plies 210, an unsupported web 720T (top ply 215 in FIG. 2) is supplied in a conventional roll form to press 710 at unwind unit 730a, and in a lengthwise machine direction M thereto. Simultaneously, an unsupported web 720B (base ply 205 in FIG. 2) is also preferably supplied in a conventional roll form to press 710 at unwind unit 730b in lengthwise machine direction M. Webs 720T and 720B are any suitable in-line web material such as a plastic (e.g., the aforementioned AET Films material) or a foil.

Unwind units 730a-b pass webs 720T-B, respectively, to first printing units 740a and 740b, respectively, where selected graphics are printed thereon (e.g., on bottom surface 215b of top ply 215, and on top surface 205a of base ply 205, as shown in FIG. 2).

Web 720B bearing graphics is then passed to first coating unit 770, where adhesive coating 320 is selectively applied thereto (as depicted in FIG. 2). Web 720B then passes to second coating unit 780, where release coating 310 is applied thereto (also as depicted in FIG. 2). While web 720B is being processed as aforedescribed, web 720T is simultaneously passed to web turning unit 750, where web 720T is turned over. The turning of web 720T may be provided by, for example, a turn-bar technique as is known in the art. Additionally, web 720T is then passed to third printing unit 760, where graphics are printed on front surface 215a of top ply 215.

Webs 720T and 720B then pass from units 760 and 780, respectively, to nip roller web joining unit 790. At unit 790, webs 720T-B are adhesively joined by way of adhesive coating 120. Referring also to FIG. 3, this adhesive joining of webs 720T-B forms the aforementioned hinge portion 220 which acts to securely bond together top ply 215 and base ply 205 along hinge axis H-H. Adhesive coating 320 also provides, in combination with release coating 310, the aforementioned releasable bond between plies 215 and 205.

Adhesively joined webs 720T-B then pass to final re-wind unit 795 where the combined webs are re-wound into a supply roll of a finished product 799P carrying individual labels 200 (as shown in FIGS. 2, 5, and 6, as the case may be). Finished product 799P is then made available to a customer for use in the customer's roll-fed wrap labeling machines.

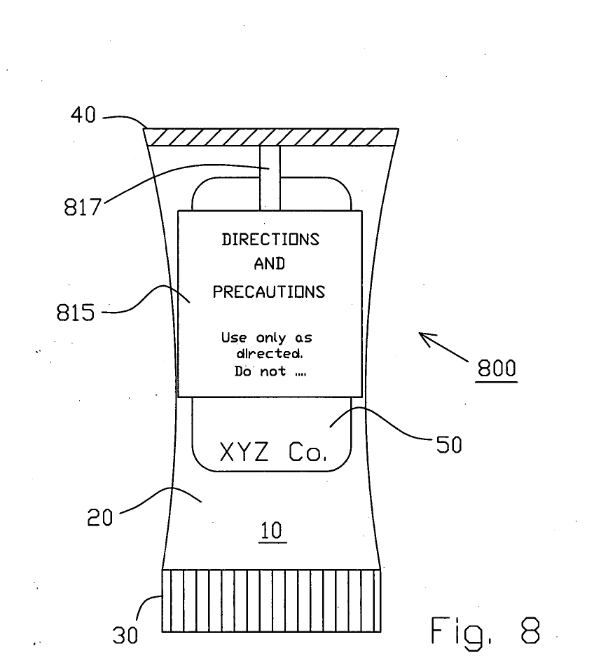

With reference now to FIG. 8, therein depicted is a single-ply article for a tube container constructed in accordance with the present invention. In FIG. 8, as was described with respect to FIG. 1, a conventional tube container 10 is typically fabricated from a pliable material 20. Container 10 includes a product dispensing end 30 which typically incorporates a dispensing cap, and an opposing filling end 40. Container 10 may also include a product identification label 50. Also depicted is a single-ply article 800, such as a label, a card, a sheet, or a coupon; these may be formed from a suitable single-ply material 815. Single-ply article 800 may optionally include a pliable attachment tongue 817. Tongue 817 may be either (i) integrally, an extension of single-ply material 815 or (ii) as shown in the drawing, a separate component joined to article 800 which may be made from material identical to or different from that of single-ply material 815, as may be desired in a particular construction of the single-ply article for a tube container. As mentioned relative to FIG. 4a, optional tongue 817 allows single-ply article 815 to conform in repose to container 10. Single-ply material 815, along with optional tongue 817, preferably is selected from any commercially available materials such as those web-like materials described above or virtually any materials that may be characterized as comprising a single ply. The materials may each, additionally, be capable of utilization in the aforementioned in-line printing and converting processes. Single-ply material 815 is also, preferably, capable of bearing printed graphics thereon as shown in FIG. 8 to maximize an amount of information that may be conveyed by single-ply article 800.

Single-ply article 800 is depicted in FIG. 8 as having been secured by the aforedescribed sealing method to container 10 at its seal (at 40) with optional tongue 817 allowing article 800 to better conform in repose to container 10. It is to be noted that the sealing method of attachment of single-ply article 800 to container 10 may be accomplished in the aforedescribed one-step or two-step operations. In the one-step operation, single-ply article 800 is securely joined to filling end 40 of tube container 10 by way of the seal at 40 provided after a product has been filled therein. In the two-step operation, container 10 is first sealed at filling end 40 by way of the sealing method. Material 815 (or tongue 817) is then subsequently secured to filling end 40 by way of (i) a separate application of adhesive (with “adhesive” including traditional adhesives, heat-activated coatings, heat sealing, chemical bonding, and thermoplastic affinity bonding, among other suitable techniques) between selected portions of the single-ply article or tongue and the seal at 40 of the tube container after the capped tube container is sealed, or (ii) a separate sealing of selected portions of the single-ply article or tongue to the seal at 40 of the tube container after the capped tube container is sealed.

Finally, and similarly to FIG. 6, a tear-off portion (not illustrated in FIG. 8) may optionally be provided anywhere in material 815 or tongue 817 for permanently removing single-ply article 800 from container 10.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

Although described by way of example as a label, a card, a sheet, or a coupon, the single ply article of the present invention may be any desired article that may be properly characterized as comprising a single ply of material, irrespective of graphics or secondary material printed or otherwise provided thereon or adhered thereto (such as a sticker, a novelty item, a premium item, a “value-added” item, a pressure-sensitive laminate construction, and the like).

It is to be further appreciated that single-ply article 800, with or without tongue 817, may alternatively be securely joined to a portion of filling end 40 as a separate, prior step before the aforedescribed steps of filling and sealing tube container 10. In this alternative embodiment, tube container 10 having such pre-attached article 800 could then be subsequently filled and sealed at filling end 40.

It is to be appreciated that any of the aforedescribed coatings and graphics may be selectively provided in any suitable combination on single-ply article 800, for a particular desired use thereof.

It is also to be understood in general that any suitable alternatives may be employed to provide the single-ply article for a tube container of the present invention, along with its manufacturing scheme. Thus, for example, the optional attributes described regarding FIG. 8 may be employed in various combinations and configurations with each other.

Lastly, the choice, of course, of compositions, sizes, and strengths of various aforementioned components of single-ply article 800 are all a matter of design choice depending upon intended uses of the present invention. Although article 800 has been depicted as being no larger than container 10, it could be any desired size.

Accordingly, these and other various changes or modifications in form and detail of the present invention may also be made therein, again without departing from the true spirit and scope of the invention as defined by the appended claims.

I claim:

1. A single-ply article for a tube container in combination, wherein a tube container includes a product dispensing end and a filling end opposite said product dispensing end, the combination comprising:
a tube container, including a crimp method seal at said filling end thereof that is created after filling said tube container with a selected product; and
a single-ply article that is securely joined to said filling end of said tube container by way of said crimp method seal.

2. The single-ply article for a tube container of claim 1, further comprising a pliable attachment tongue extending outwardly from said single-ply article such that said tongue is securely joined to said filling end of said tube container at said seal.

3. The single-ply article for a tube container of claim 1, further comprising a tear-off portion for permanently removing said single-ply article from said tube container.

4. The single-ply article for a tube container of claim 2, further comprising a tear-off portion for permanently removing said single-ply article from said tube container.

5. The single-ply article for a tube container of claim 1, wherein said single-ply article is selected from the group consisting of a label, a card, a sheet, and a coupon.

6. The single-ply article for a tube container of claim 2, wherein said single-ply article is selected from the group consisting of a label, a card, a sheet, and a coupon.

7. The single-ply article for a tube container of claim 3, wherein said single-ply article is selected from the group consisting of a label, a card, a sheet, and a coupon.

8. The single-ply article for a tube container of claim 4, wherein said single-ply article is selected from the group consisting of a label, a card, a sheet, and a coupon.

9. The single-ply article for a tube container of claim 2, wherein said pliable attachment tongue is selected from the group consisting of (i) integrally, an extension of said single-ply article and (ii) a separate component.

10. The single-ply article for a tube container of claim 4, wherein said pliable attachment tongue is selected from the group consisting of (i) integrally, an extension of said single-ply article and (ii) a separate component.

11. The single-ply article for a tube container of claim 6, wherein said pliable attachment tongue is selected from the group consisting of (i) integrally, an extension of said single-ply article and (ii) a separate component.

12. The single-ply article for a tube container of claim 8, wherein said pliable attachment tongue is selected from the group consisting of (i) integrally, an extension of said single-ply article and (ii) a separate component.

13. A single-ply article for a tube container in combination, wherein a tube container includes a product dispensing end and a filling end opposite said product dispensing end, the combination comprising:
a tube container, including a crimp method seal at said filling end thereof that is created after filling said tube container with a selected product; and
a single-ply article that is securely joined to said filling end of said tube container after said tube container is crimped shut, in a two-step operation.

14. The single-ply article for a tube container of claim 13, further comprising a pliable attachment tongue extending outwardly from said single-ply article such that said tongue is securely joined to said filling end of said tube container after said tube container is crimped shut, in a two-step operation.

15. The single-ply article for a tube container of claim 13, further comprising a tear-off portion for permanently removing said single-ply article from said tube container.

16. The single-ply article for a tube container of claim 14, further comprising a tear-off portion for permanently removing said single-ply article from said tube container.

17. The single-ply article for a tube container of claim 13, wherein said single-ply article is selected from the group consisting of a label, a card, a sheet, and a coupon.

18. The single-ply article for a tube container of claim 14, wherein said single-ply article is selected from the group consisting of a label, a card, a sheet, and a coupon.

19. The single-ply article for a tube container of claim 15, wherein said single-ply article is selected from the group consisting of a label, a card, a sheet, and a coupon.

20. The single-ply article for a tube container of claim 16, wherein said single-ply article is selected from the group consisting of a label, a card, a sheet, and a coupon.

21. The single-ply article for a tube container of claim 14, wherein said pliable attachment tongue is selected from the group consisting of (i) integrally, an extension of said single-ply article and (ii) a separate component.

22. The single-ply article for a tube container of claim 16, wherein said pliable attachment tongue is selected from the group consisting of (i) integrally, an extension of said single-ply article and (ii) a separate component.

23. The single-ply article for a tube container of claim 18, wherein said pliable attachment tongue is selected from the group consisting of (i) integrally, an extension of said single-ply article and (ii) a separate component.

24. The single-ply article for a tube container of claim 20, wherein said pliable attachment tongue is selected from the group consisting of (i) integrally, an extension of said single-ply article and (ii) a separate component.

25. A single-ply article for a tube container in combination, wherein a tube container includes a product dispensing end and a filling end opposite said product dispensing end, the combination comprising:
a tube container; and
a single-ply article,
wherein (i) said single-ply article is securely joined to a portion of said filling end of said tube container as a separate, prior step before said tube container is filled with a selected product, and (ii) said tube container includes a crimp method seal at said filling end thereof that is created after filling said tube container with the selected product.

26. The single-ply article for a tube container of claim 25, further comprising a pliable attachment tongue extending outwardly from said single-ply article such that said tongue is securely joined to a portion of said filling end of said tube container as a separate, prior step before said tube container is filled with the selected product.

27. The single-ply article for a tube container of claim 25, further comprising a tear-off portion for permanently removing said single-ply article from said tube container.

28. The single-ply article for a tube container of claim 26, further comprising a tear-off portion for permanently removing said single-ply article from said tube container.

29. The single-ply article for a tube container of claim 25, wherein said single-ply article is selected from the group consisting of a label, a card, a sheet, and a coupon.

30. The single-ply article for a tube container of claim 26, wherein said single-ply article is selected from the group consisting of a label, a card, a sheet, and a coupon.

31. The single-ply article for a tube container of claim 27, wherein said single-ply article is selected from the group consisting of a label, a card, a sheet, and a coupon.

32. The single-ply article for a tube container of claim 28, wherein said single-ply article is selected from the group consisting of a label, a card, a sheet, and a coupon.

33. The single-ply article for a tube container of claim 26, wherein said pliable attachment tongue is selected from the group consisting of (i) integrally, an extension of said single-ply article and (ii) a separate component.

34. The single-ply article for a tube container of claim 28, wherein said pliable attachment tongue is selected from the group consisting of (i) integrally, an extension of said single-ply article and (ii) a separate component.

35. The single-ply article for a tube container of claim 30, wherein said pliable attachment tongue is selected from the group consisting of (i) integrally, an extension of said single-ply article and (ii) a separate component.

36. The single-ply article for a tube container of claim 32, wherein said pliable attachment tongue is selected from the group consisting of (i) integrally, an extension of said single-ply article and (ii) a separate component.
